(19) United States
(12) Patent Application Publication
(10) Pub. No.: US 2024/0060651 A1
(43) Pub. Date: Feb. 22, 2024

(54) COOKING APPLIANCE

(71) Applicant: SAMSUNG ELECTRONICS CO., LTD., Suwon-si (KR)

(72) Inventors: Geunyong PARK, Suwon-si (KR); Sangjin JEONG, Suwon-si (KR); Youseop LEE, Suwon-si (KR); Seunghee CHO, Suwon-si (KR)

(73) Assignee: SAMSUNG ELECTRONICS CO., LTD., Suwon-si (KR)

(21) Appl. No.: 18/501,673

(22) Filed: Nov. 3, 2023

Related U.S. Application Data
(63) Continuation of application No. PCT/KR2022/005681, filed on Apr. 21, 2022.

(30) Foreign Application Priority Data
May 10, 2021 (KR) 10-2021-0060185

(51) Int. Cl. F24C 15/02

(52) U.S. Cl. CPC F24C 15/024

(57) ABSTRACT

A cooking appliance comprising a main body to accommodate a cooking chamber; a door to open and close the cooking chamber; and a handle mountable on a front of the door, the handle including a contact portion. The door comprises: a door frame; and a front panel arrangeable in front of the door frame so that while the front panel is arranged in front of the door frame, the front panel is in contact with the contact portion of the handle while the handle is mounted on the front of the door, the front panel including a support protrusion that extends toward the door frame from an area of the front panel which corresponds to the contact portion of the handle in contact with the front panel of the door to thereby prevent deformation of the door due to operation of the handle.

### CROSS-REFERENCE TO RELATED APPLICATION

This application is a continuation application, under 35 U.S.C. § 111(a), of international application No. PCT/KR2022/005681, filed on Apr. 21, 2022, which claims priority under 35 U. S. C. § 119 to Korean Patent Application No. 10-2021-0060185, filed May 10, 2021, the disclosures of which are incorporated herein by reference in their entireties.

### BACKGROUND

### Field

The present disclosure relates to a cooking appliance, and more specifically, to a cooking appliance including a front panel with an improved structure.

Description of the Related Art A cooking appliance is an appliance for heating and cooking an object to be cooked, such as food, and refers to an appliance capable of performing various functions related to cooking, such as heating, defrosting, drying, and sterilizing the object to be cooked.

Examples of such a cooking appliance include an oven, such as a gas oven or an electric oven, a microwave heating device (hereinafter referred to as a microwave), a gas range, an electric range, a gas grill, or an electric grill.

In general, an oven is a device for cooking food by transferring heat directly to the food or by heating an inside of a cooking chamber by means of a heat source that produces heat, such as a heater, and a microwave is a device for cooking food using frictional heat generated by disturbing the arrangement of molecules in the food with electromagnetic waves as a heat source.

Doors of cooking appliance include a door frame and a front panel provided in front of the door frame to form an exterior. In addition, a handle is mounted on the front of the door for a user to grip.

However, a fastening member is coupled to couple the door and the handle, and thus the front panel may receive an external force toward the door frame, which may cause unevenness in the relatively thin front panel and impair aesthetics.

### SUMMARY

One aspect of the disclosure provides a cooking appliance including: a main body to accommodate a cooking chamber; a door to open and close the cooking chamber while the cooking chamber is accommodated in the main body; and a handle mountable on a front of the door and including a contact portion, wherein the door includes a door frame, and a front panel arrangeable in front of the door frame so that while the front panel is arranged in front of the door frame, the front panel is in contact with the contact portion of the handle while the handle is mounted on the front of the door, and the front panel including a support protrusion extending toward the door frame from an area of the front panel which corresponds to the contact portion of the handle in contact with the front panel of the door to thereby prevent deformation of the door due to operation of the handle.

Also, the support protrusion may be in contact with a front side of the door frame to allow the front panel and the door frame to be spaced apart from each other.

Also, the support protrusion may be recessed rearward from a front side of the front panel.

Also, the support protrusion may include a connection portion extending rearward of the front panel, and a support portion connectable to the connection portion to be in surface contact with a front side of the door frame.

Also, the handle may further include a protruding portion extending rearward from the contact portion to allow a fastening member to be inserted.

Also, the support protrusion may be formed at a position facing the contact portion of the handle.

Also, the front panel may include a handle coupling portion formed to be cut to allow the protruding portion of the handle to pass through and formed in an area corresponding to the contact portion of the handle.

Also, the support protrusion may be formed at an outer side of the front panel than the handle coupling portion.

Also, the door frame may include a handle insertion portion extending rearward to receive the protruding portion passing through the handle coupling portion.

Also, the cooking appliance may further include a rear frame behind the door frame and in which a coupling hole is formed at a position corresponding to the handle insertion portion, and the fastening member may pass through the coupling hole and the handle insertion portion from behind, and insertable into the protruding portion of the handle, so as to allow the contact portion of the handle to come into close contact with a front side of the front panel.

Also, the support protrusion may be formed in an area where the handle is mounted on the front panel.

Also, the support protrusion may be in a circular shape.

Also, the door frame may include a guide protrusion extending toward the handle to be received in the handle, and the front panel may include a protrusion through portion through which the guide protrusion passes.

Also, the guide protrusion may be formed at a position biased to one side with respect to a direction in which the handle extends to prevent misassembly of the handle.

Also, the front panel may include a stainless material.

Another aspect of the disclosure provides a cooking appliance including: a main body to accommodate a cooking chamber; a door frame in front of the cooking chamber, a front panel to cover a front side of the door frame, a handle mountable on a front of the front panel and including a contact portion in contact with the front panel, and a support protrusion, formed in an area corresponding to the contact portion of the handle, to space the door frame apart from the front panel by protruding from one of the door frame or the front panel.

Also, the support protrusion may extend toward the door frame from the front panel.

Also, the handle may include a protruding portion extending toward the front panel from the contact portion to allow a fastening member to be inserted.

Also, the front panel may include a handle coupling portion formed to be cut to allow the protruding portion of the handle to pass through, and the support protrusion may be formed outside of the handle coupling portion.

Still another aspect of the disclosure provides a cooking appliance including: a main body to accommodate a cooking chamber; a door frame rotatably with respect to the main body, a front panel to cover a front side of the door frame, a handle mountable on a front of the front panel and including a contact portion in contact with the front panel, and a support protrusion recessed inward from the front panel at a position facing the contact portion of the handle and the support protrusion including a connection portion extending in a space between the front panel and the door frame, and a support protrusion in surface contact with a front side of the door frame.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view of a cooking appliance according to an embodiment of the disclosure.

FIG. 2 is a front view illustrating an interior of the cooking appliance according to an embodiment of the disclosure.

FIG. 3 is an exploded perspective view illustrating the handle, a door, and a control unit of the cooking appliance according to an embodiment of the disclosure.

FIG. 4 is a view illustrating that an upper portion of the handle of the cooking appliance is coupled to the door according to an embodiment of the disclosure.

FIG. 5 is a view illustrating that a lower portion of the handle of the cooking appliance is coupled to the door according to an embodiment of the disclosure.

FIG. 6 is a cross-sectional view of the cooking appliance according to an embodiment of the disclosure.

FIG. 7 is an enlarged view of a portion A of FIG. 6 according to an embodiment of the disclosure.

FIG. 8 is an enlarged view of a portion B of FIG. 6 according to an embodiment of the disclosure.

FIG. 9 is a view illustrating a state in which a fastening member is coupled at a rear of the door of the cooking appliance according to an embodiment of the disclosure.

### DETAILED DESCRIPTION

Configurations illustrated in the embodiments and the drawings described in the present specification are only the preferred embodiments of the disclosure, and thus it is to be understood that various modified examples, which may replace the embodiments and the drawings described in the specification, are possible when filing the present application.

Also, like reference numerals or symbols denoted in the drawings of the specification represent members or components that perform the approximately same functions.

Also, the terms used in the specification are merely used to describe embodiments, and are not intended to limit and/or restrict the disclosure. An expression used in the singular encompasses the expression of the plural, unless it has a clearly different meaning in the context. In the specification, it is to be understood that the terms such as “comprising”, “including” or “having”, etc., are intended to indicate the existence of the features, numbers, steps, operations, components, parts, or combinations thereof disclosed in the specification, and are not intended to preclude the possibility that one or more other features, numbers, steps, operations, components, parts, or combinations thereof may exist or may be added.

Also, it will be understood that, although the terms including ordinal numbers, such as “first”, “second”, etc., may be used herein to describe various components, these components should not be limited by these terms. These terms are only used to distinguish one component from another. For example, a first component could be termed a second component, and, similarly, a second component could be termed a first component, without departing from the scope of the disclosure. As used herein, the term “and/or” includes any and all combinations of one or more of associated listed items.

The disclosure is directed to providing a cooking appliance with an improved structure to minimize unevenness in a front panel and increase rigidity.

Unevenness that may be formed in a front panel when a handle is coupled to the front panel may be minimized.

A support protrusion is provided in a bead form, thereby increasing rigidity of a portion where a handle is mounted.

Hereinafter, embodiments of the disclosure will be described in detail with reference to the accompanying drawings.

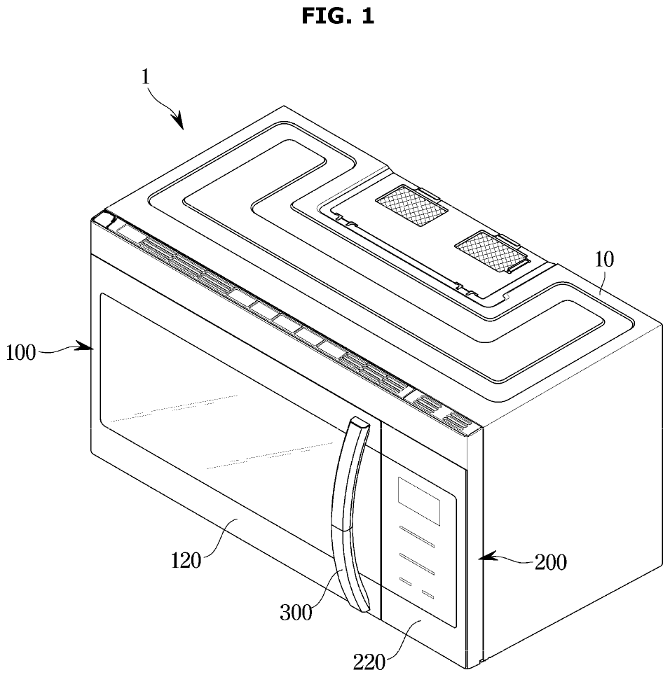

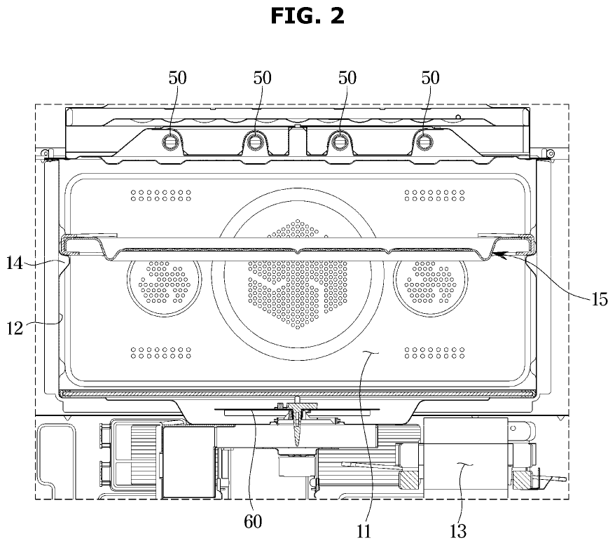

FIG. 1 is a perspective view of a cooking appliance according to an embodiment of the disclosure. FIG. 2 is a front view illustrating an interior of the cooking appliance according to an embodiment of the disclosure.

Referring to FIG. 1 and FIG. 2, a cooking appliance 1 may include a main body 10 forming an exterior.

The cooking appliance 1 may include a door 100 provided to open and close a cooking chamber 11. The door 100 may be provided rotatably with respect to the main body 10 to open and close the cooking chamber 11.

The cooking appliance 1 may include a handle 300 mounted on the door 100 to be gripped.

The cooking appliance 1 may include a control unit 200 provided to be operated by a user.

Both the door 100 and the control unit may be mounted on a front of the main body 10. The control unit may include a control panel 210 receiving a user command. A shape of the control panel 210 may not be limited to that shown in FIG. 1.

Referring to FIG. 2, the cooking chamber 11 may be provided in an approximately rectangular shape having a long side.

A cabinet 12 may be provided inside the main body 10 to form the cooking chamber 11. A predetermined space may be formed between the main body 10 and the cabinet 12.

In addition, the main body 10 and the cabinet 12 may be provided to be opened in a forward direction of the cooking appliance 1. A user may place an object to be cooked inside the cooking chamber 11 through the open portion.

The cooking appliance 1 may include a machine room 13 provided below the cooking chamber 11. A variety of electrical components that drive the cooking appliance 1 may be disposed inside the machine room 13.

The cooking appliance 1 may include a shelf 15 positioned inside the cooking chamber 11 to allow a user to place an object to be cooked. The shelf 15 may be detachably disposed inside the cooking chamber 11.

The cooking chamber 11 may include a holding part 14 formed on both sides of the cooking chamber 11 to allow the shelf 15 to be fixedly placed between upper and lower surfaces of the cooking chamber 11.

More specifically, the holding part 14 may protrude into the cabinet 12. However, a shape of the holding part 14 is not limited thereto, and the holding part 14 may be provided in a manner where a structure such as a separate bracket is coupled to the cabinet 12.

The cooking appliance 1 may include a first heating source 50 and a second heating source 60. The first heating source 50 and the second heating source 60 may provide heat to a cooking object positioned on the shelf 15 so that the cooking object is cooked.

In addition, the cooking object may be located on the lower surface of the cooking chamber 11 without the shelf 15, and in this case, the first heating source 50 and the second heating source 60 may also provide heat to the cooking object located on the lower surface of the cooking chamber 11.

The first heating source 50 may include a plurality of heaters generating radiant heat. The plurality of heaters may radiate heat generated by the plurality of heaters themselves, thereby directly transferring heat to the cooking object.

The second heating source 60 may include a magnetron generating high frequency waves. The high frequency waves generated by the magnetron are irradiated into the cooking object, and thus an inside of the cooking object may be cooked by frictional heat between molecules of the cooking object generated by repeatedly converting the molecular arrangement of moisture contained in the cooking object.

The second heating source 60 may be disposed in the machine room 13. The second heating source 60 oscillates high frequency waves from the machine room 13 toward the lower surface of the cooking chamber 11, and the high frequency waves may pass through the lower surface of the cooking chamber 11 and be irradiated to the shelf 15 or the cooking object.

However, a form of the heating source of the cooking appliance 1 according to an embodiment of the disclosure is not limited thereto and may be provided to include only one of the first heating source 50 or the second heating source 60.

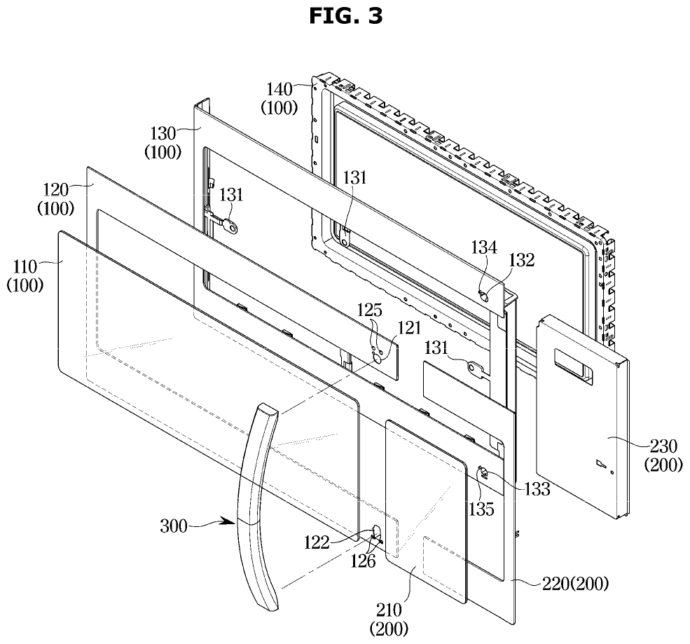

FIG. 3 is an exploded perspective view illustrating a handle, a door, and a control unit of the cooking appliance according to an embodiment of the disclosure.

Referring to FIG. 3, the cooking appliance 1 may include the handle 300, the door 100 and the control unit 200.

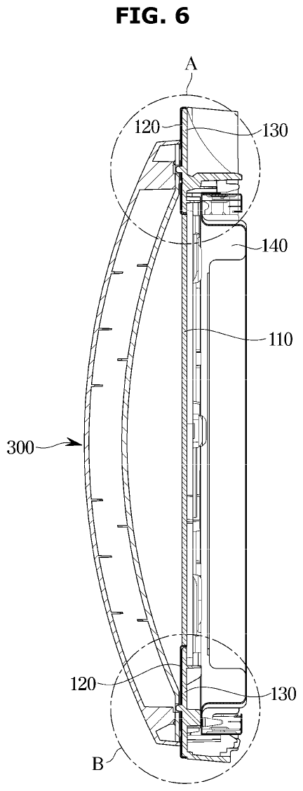

The door 100 may include a transparent member 110 (FIG. 6).

The transparent member 110 is provided to allow a user to look inside of the cooking chamber 11, when the cooking chamber 11 is closed by the door 100.

The transparent member 110 may include a plastic or glass material.

The door 100 may include a front panel 120 and a door frame 130.

The front panel 120 may be mounted in front of the door frame 130. More specifically, the front panel 120 may be attached to the door frame 130 using an inlay method.

For example, the front panel 120 may be attached to the door frame 130 using heat, pressure, and the like, after applying colors and letters to a sheet-type film by a silk screen technique.

Accordingly, the front panel 120 may cover a front of the door frame 130, thereby improving the aesthetics of the cooking appliance 1.

That is, the front panel 120 may serve as a decorative panel.

The front panel 120 may include a first handle coupling portion 121 and a second handle coupling portion 122. The first handle coupling portion 121 and the second handle coupling portion 122 may be formed by cutting the front panel 120.

The first handle coupling portion 121 may be provided on an upper portion of the front panel 120, and the second handle coupling portion 122 may be provided on a lower portion of the front panel 120.

The front panel 120 may be provided in an approximately ‘ [symbol] ’ of Korean letter shape. The transparent member 110 is provided at an open center portion of the front panel 120 to allow a user to see the inside of the cooking chamber 11.

The front panel 120 may include a support protrusion. The support protrusion may include a first support protrusion 125 and a second support protrusion 126.

The first support protrusion 125 may be provided on an upper portion of the front panel 120, and the second support protrusion 126 may be provided on a lower portion of the front panel 120, which will be described in detail later.

The door frame 130 may be provided in an approximately rectangular ring shape with an open center.

The door frame 130 may include a plurality of seating portions 131 extending from an outer edge of the door frame 130 toward the center. The transparent member 110 may be prevented from moving toward the cooking chamber 11 by the plurality of seating portions 131, and may be seated and supported on the plurality of seating portions 131.

The door frame 130 may include a first handle insertion portion 132 and a second handle insertion portion 133.

The first handle insertion portion 132 may be provided on an upper portion of the door frame 130. The second handle insertion portion 133 may be provided on a lower portion of the door frame 130.

More specifically, the first handle insertion portion 132 may be formed at a position corresponding to the first handle coupling portion 121, and the second handle insertion portion 133 may be formed at a position corresponding to the second handle coupling portion 122.

The first handle insertion portion 132 and the second handle insertion portion 133 may be recessed rearward of the door frame 130.

A first protruding portion 320 and a second protruding portion 330 of the handle 300 may be inserted into the first handle insertion portion 132 and the second handle insertion portion 133 of the door frame 130, respectively, which will be described in detail later.

The door frame 130 may include a guide protrusion. The guide protrusion may protrude forward from the front side of the door frame 130. More specifically, the guide protrusion may extend toward the handle 300 and may be received in the handle 300.

The door 100 may include a rear frame 140.

The rear frame 140 may be coupled to a rear side of the door frame 130. A plurality of choke structures are formed at an edge of the rear frame 140 to prevent electromagnetic waves in the cooking chamber 11 from leaking out.

The control unit 200 may include the control panel 210, a control front panel 220 and a support frame 230.

A user command may be input to the cooking appliance 1 through the control panel 210. The control panel 210 may be provided in a touch type or a pressure-sensitive type. In addition, the control panel 210 is not limited thereto and may be provided in various types.

The control front panel 220 may be disposed on the same plane as the front panel 120 of the door 100. The control front panel 220 may also be coupled to the support frame 230 by the same inlay method as the front panel 120 of the door 100.

Furthermore, in addition to the components of the door 100 shown and described in FIG. 3, a separate shielding member or a fixing frame may be provided. The fixing frame is provided to fix the shielding member.

Accordingly, fragments of the cooking object may be prevented from being ejected from within the cooking chamber 11 and impacting the door 100. The shielding member may also be provided for more hygienic maintenance of the door 100.

A configuration of the handle 300 will be described in detail later.

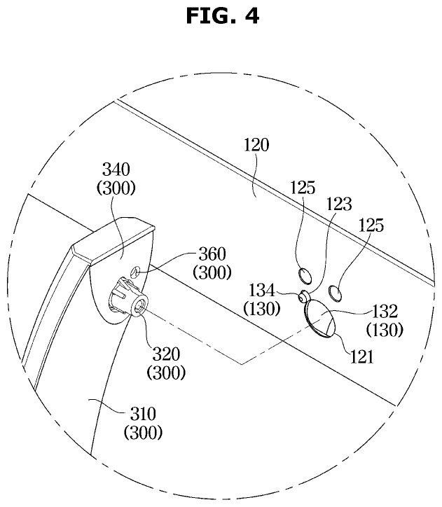

FIG. 4 is a view illustrating that an upper portion of the handle 300 of the cooking appliance 1 according to an embodiment of the disclosure is coupled to the door 100.

Referring to FIG. 4, the handle 300 may be coupled to the door 100. In particular, the handle 300 may be provided to contact the front panel 120 of the door 100.

The handle 300 may be mounted on a front of the door 100.

The handle 300 may include a handle case 310, a first contact portion 340, a first protruding portion 320 and a first guide insertion portion 360.

The handle case 310 may extend in a vertical direction to form an exterior of the handle 300. Although the handle case 310 of the cooking appliance 1 according to an embodiment of the disclosure is shown as extending in a streamlined shape, a shape of the handle 300 may not be limited thereto.

The first contact portion 340 may be provided in an upper portion of the handle 300. The first contact portion 340 may be provided as a contact portion between the handle 300 and the door 100.

More specifically, the first contact portion 340 may be provided as a portion where the handle 300 and a front side of the front panel 120 of the door 100 come into contact.

Accordingly, a surface where the first contact portion 340 is in contact with the door 100 may be approximately parallel to a front side of the door 100.

The first protruding portion 320 may extend rearward from the first contact portion 340 to allow the fastening member 400 to be described later to be inserted into the handle 300.

More specifically, the first protruding portion 320 may be provided in a boss form. Accordingly, the first protruding portion 320 may be provided in a pillar shape where a space for inserting the fastening member 400 is formed therein.

In other words, the first protruding portion 320 may extend from the first contact portion 340 toward the door 100. The first protruding portion 320 may pass through the first handle coupling portion 121 of the front panel 120 to be described later, and may be inserted into the first handle insertion portion 132 of the door frame 130, which will be described later.

The first guide insertion portion 360 may be formed on the first contact portion 340. Specifically, the first guide insertion portion 360 may be formed by partially cutting the first contact portion 340.

Also, the first guide insertion portion 360 may be recessed from the first contact portion 340 in an inward direction of the handle 300.

A shape of the first guide insertion portion 360 may be any shape as long as it forms a space for inserting a first guide protrusion 134 of the door frame 130 to be described later.

The front panel 120 may include the first handle coupling portion 121, a first protrusion through portion 123, and the first support protrusion 125.

The first handle coupling portion 121 may be formed by cutting a portion of the front panel 120. The first protruding portion 320 of the handle 300 may pass through the front panel 120 through the first handle coupling portion 121.

Accordingly, the first handle coupling portion 121 may have a size corresponding to a diameter of the first protruding portion 320 of the handle 300, without being limited thereto. The diameter of the first handle coupling portion 121 may be provided to be slightly smaller than the diameter of the first protruding portion 320 of the handle 300 to increase a coupling force between the handle 300 and the door 100.

The first handle coupling portion 121 may be cut to allow the first protruding portion 320 to pass therethrough, and may be formed in an area corresponding to the first contact portion 340.

The first protrusion through portion 123 may be formed on a side portion of the first handle coupling portion 121. The first protrusion through portion 123 may be provided to allow the first guide protrusion 134 of the door frame 130 to pass through the front of the front panel 120.

Accordingly, the first protrusion through portion 123 may be formed at a position corresponding to the first guide protrusion 134 of the door frame 130.

The first guide protrusion 134 may be formed to be biased to one side with respect to a direction in which the handle 300 extends.

Accordingly, when the handle 300 is flipped upside down and is misassembled, the handle 300 may be interfered with the first guide protrusion 134 passing through the front panel 120. Accordingly, the first guide protrusion 134 may prevent the handle 300 from being misassembled in a vertical direction.

The first handle insertion portion 132 of the door frame 130 provided at a rear of the front panel 120 may extend rearward to accommodate the first protruding portion 320 passing through the first handle coupling portion 121.

The first support protrusion 125 may be provided in an area corresponding to the first contact portion 340 of the handle 300. Specifically, the first support protrusion 125 may be provided to face the first contact portion 340 of the handle 300, when the handle 300 is coupled to the door 100.

The first support protrusion 125 may be provided in a circular shape. However, a shape of the first support protrusion 125 is not limited thereto.

The first support protrusion 125 may be formed at an outer side of the front panel 120 than the first handle coupling portion 121. When an external force is applied to the front panel 120, an inner side of the front panel 120 may be partially covered by the handle 300.

However, the outer side of the front panel 120 is not covered with the handle 300 and may be easily exposed to a user. Accordingly, the first support protrusion 125 is formed at the outer side than the first handle coupling portion 121, and thus unevenness of the front panel 120 may be invisible to the user.

However, a position of the first support protrusion 125 is not limited thereto. In addition, in FIG. 4, although the first support protrusion 125 is shown as being formed in two on the upper portion of the first handle coupling portion 121, the number of the first support protrusions 125 is not limited thereto.

For example, the first support protrusion 125 may be provided as one, not in plurality. The first support protrusion 125 may be a single protrusion and may be formed in an area corresponding to the first contact portion 340 of the handle 300.

In addition, the area where the first support protrusion 125 is formed is not limited to that shown in FIG. 4, and the first support protrusion 125 may be formed anywhere as long as it faces the first contact portion 340 of the handle 300. The first support protrusion 125 may also have the same area as the first contact portion 340 of the handle 300.

The first support protrusion 125 may prevent deformation of the front panel 120. More specifically, the first support protrusion 125 may be provided to prevent unevenness from being formed on the front panel 120 by the tightening force of the fastening member 400, when the handle 300 is coupled to the door 100.

The first support protrusion 125 may extend toward the door frame 130 in an area corresponding to the first contact portion 340 of the handle 300.

A structure of the first support protrusion 125 will be described in detail later.

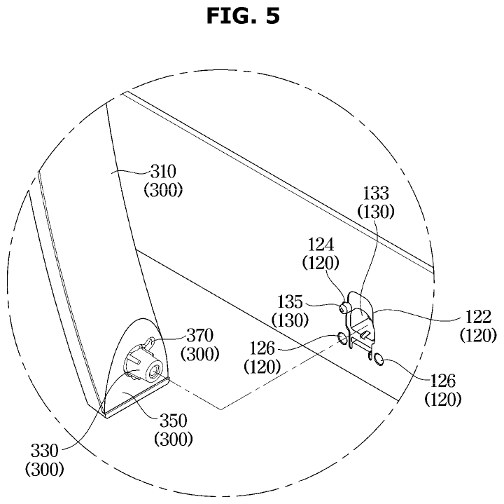

FIG. 5 is a view illustrating that a lower portion of the handle of the cooking appliance according to an embodiment of the disclosure is coupled to the door.

A lower portion of the handle 300 may also be provided in a structure similar to that of the upper portion of the handle 300 as described above in FIG. 4.

As shown in FIG. 5, a second contact portion 350 may be provided in a lower portion of the handle 300. The second contact portion 350 may be provided as a contact portion between the handle 300 and the door 100.

More specifically, the second contact portion 350 may be provided as a portion where the handle 300 and a front side of the front panel 120 of the door 100 come into contact. Accordingly, a surface where the second contact portion 350 is in contact with the door 100 may be approximately parallel to the front side of the door 100.

The second protruding portion 330 may extend rearward from the second contact portion 350 to allow the fastening member 400 to be described later to be inserted into the handle 300.

More specifically, the second protruding portion 330 may be provided in a boss form. Accordingly, the second protruding portion 330 may be provided in a pillar shape where a space for inserting the fastening member 400 is formed therein.

In other words, the second protruding portion 330 may extend from the second contact portion 350 toward the door 100.

The second protruding portion 330 may pass through the second handle coupling portion 122 of the front panel 120 to be described later, and may be inserted into the second handle insertion portion 133 of the door frame 130, which will be described later.

The second guide insertion portion 370 may be formed in the second contact portion 350. Specifically, the second guide insertion portion 370 may be formed by partially cutting the second contact portion 350.

Also, the second guide insertion portion 370 may be recessed from the second contact portion 350 in an inward direction of the handle 300. A shape of the second guide insertion portion 370 may be any shape as long as it forms a space for inserting the first guide protrusion 134 of the door frame 130 to be described later.

The front panel 120 may include the second handle coupling portion 122, a second protrusion through portion 124, and the second support protrusion 126.

The second handle coupling portion 122 may be formed by cutting a portion of the front panel 120. The second protruding portion 330 of the handle 300 may pass through the front panel 120 through the second handle coupling portion 122.

Accordingly, the second handle coupling portion 122 may have a size corresponding to a diameter of the second protruding portion 330 of the handle 300, without being limited thereto. The diameter of the second handle coupling portion 122 may be provided to be slightly smaller than the diameter of the second protruding portion 330 of the handle 300 to increase a coupling force between the handle 300 and the door 100.

The second handle coupling portion 122 may be cut to allow the second protrusion 320 to pass there through, and may be formed in an area corresponding to the second contact portion 350.

The second protrusion through portion 124 may be formed on a side portion of the second handle coupling portion 122. The second protrusion through portion 124 may be provided to allow the second guide protrusion 135 of the door frame 130 to pass through the front of the front panel 120. Accordingly, the second protrusion through portion 124 may be formed at a position corresponding to the second guide protrusion 135 of the door frame 130.

The second guide protrusion 135 may be formed to be biased to one side with respect to a direction in which the handle 300 extends.

Accordingly, when the handle 300 is flipped upside down and is misassembled, the handle 300 may be interfered with the second guide protrusion 135 passing through the front panel 120. Accordingly, the second guide protrusion 135 may prevent the handle 300 from being misassembled in a vertical direction.

The second handle insertion portion 133 of the door frame 130 provided at a rear of the front panel 120 may extend rearward to accommodate the second protruding portion 330 passing through the second handle coupling portion 122.

The second support protrusion 126 may be provided in an area corresponding to the second contact portion 350 of the handle 300. Specifically, the second support protrusion 126 may be provided to face the second contact portion 350 of the handle 300, when the handle 300 is coupled to the door 100.

The second support protrusion 126 may be provided in a circular shape. However, a shape of the second support protrusion 126 is not limited thereto.

The second support protrusion 126 may be formed at an outer side of the front panel 120 than the second handle coupling portion 122. When an external force is applied to the front panel 120, an inner side of the front panel 120 may be partially covered by the handle 300.

However, the outer side of the front panel 120 is not covered with the handle 300 and may be easily exposed to a user. Accordingly, the second support protrusion 126 is formed at the outer side than the second handle coupling portion 122, and thus unevenness of the front panel 120 may be invisible to the user.

However, a position of the second support protrusion 126 is not limited thereto. In addition, in FIG. 5, although the second support protrusion 126 is shown as being formed in two on the upper portion of the second handle coupling portion 122, the number of the second support protrusions 126 is not limited thereto.

For example, the second support protrusion 126 may be provided as one, not in plurality. The second support protrusion 126 may be a single protrusion, and may be formed in an area corresponding to the second contact portion 350 of the handle 300.

In addition, the area where the second support protrusion 126 is formed is not limited to that shown in FIG. 5, and may be formed anywhere as long as it faces the second contact portion 350 of the handle 300. The second support protrusion 126 may also have the same area as the second contact portion 350 of the handle 300.

The second support protrusion 126 may prevent deformation of the front panel 120.

More specifically, the second support protrusion 126 may be provided to prevent unevenness from being formed on the front panel 120 by the tightening force of the fastening member 400, when the handle 300 is coupled to the door 100.

The second support protrusion 126 may extend toward the door frame 130 in an area corresponding to the second contact portion 350 of the handle 300.

A structure of the second support protrusion 126 will be described in detail later.

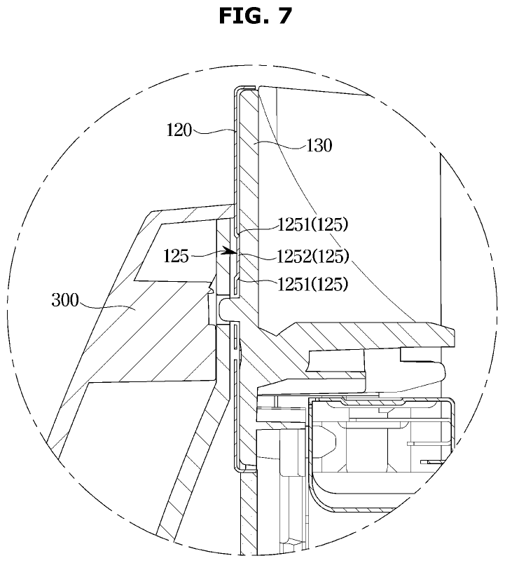

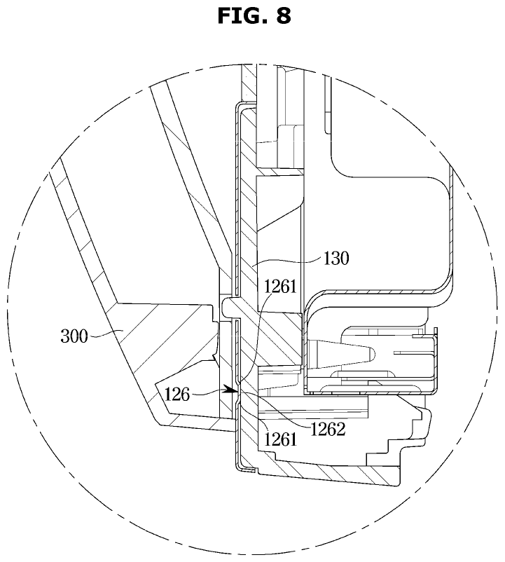

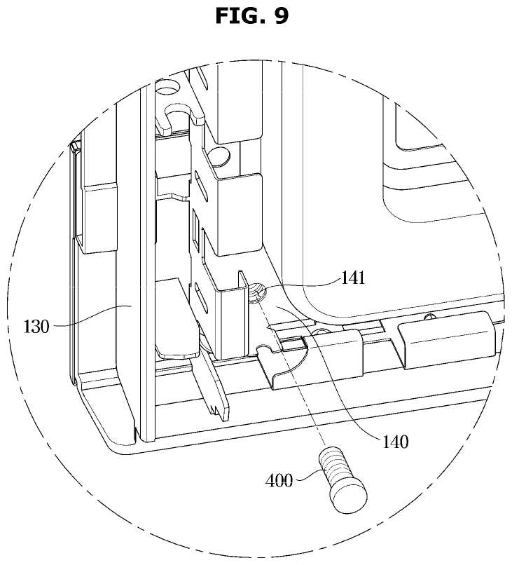

FIG. 6 is a cross-sectional view of the cooking appliance according to an embodiment of the disclosure. FIG. 7 is an enlarged view of a portion A of FIG. 6. FIG. 8 is an enlarged view of a portion B of FIG. 6. FIG. 9 is a view illustrating a state in which a fastening member is coupled at a rear of the door of the cooking appliance according to an embodiment of the disclosure.

As shown in FIG. 6, the handle 300 may be coupled to a front of the door 100. More specifically, the handle 300 may be coupled to the front of the door 100 to be in contact with the front panel 120 of the door 100.

The front panel 120 of the door 100 may cover a front of the door frame 130. Centers of the front panel 120, the door frame 130, and the rear frame 140 of the door 100 may be substantially open.

The transparent member 110 may be disposed at a center of the door 100 to block an open portion and allow a user to see an inside from an outside.

Hereinafter, a structure and a relationship of the first support protrusion 125 and the second support protrusion 126 of the cooking appliance 1 according to an embodiment of the disclosure will be described in detail with reference to FIG. 7 and FIG. 8.

Referring to FIG. 7, the first support protrusion 125 may be recessed toward the door frame 130 from the front panel 120.

Specifically, the first support protrusion 125 may be recessed rearward from the front side of the front panel 120.

The first support protrusion 125 may contact a front side of the door frame 130 to allow the front panel 120 and the door frame 130 to be spaced apart from each other.

The first support protrusion 125 may include a first connection portion 1251 and a first support portion 1252.

The first connection portion 1251 may be provided as a portion extending from the front panel 120 to a rear of the front panel 120. That is, the first connection portion 1251 may serve to transfer a load.

The first support portion 1252 may be connected to the first connection portion 1251 and may be in surface contact with the front side of the door frame 130. That is, the first support portion 1252 may serve to support a load.

Referring to FIG. 8, the second support protrusion 126 may be recessed from the front panel 120 toward the door frame 130.

Specifically, the second support protrusion 126 may be recessed rearward from the front side of the front panel 120.

The second support protrusion 126 may contact the front side of the door frame 130 to allow the front panel 120 and the door frame 130 to be spaced apart from each other.

The second support protrusion 126 may include a second connection portion 1261 and a second support portion 1262.

The second connection portion 1261 may be provided as a portion extending from the front panel 120 to a rear of the front panel 120. That is, the second connection portion 1261 may serve to transfer a load.

The second support portion 1262 may be connected to the second connection portion 1261 and may be in surface contact with the front side of the door frame 130. That is, the second support portion 1262 may serve to support a load.

A method of coupling the fastening member 400 to the door 100 is described with reference to FIG. 9. Although a lower corner side of the door 100 is described as an example, the coupling method may be equally applied to an upper corner side of the door 100, and thus a description thereof will be omitted.

The rear frame 140 may be disposed behind the door frame 130 and include a coupling hole 141 formed at a position corresponding to the second handle insertion portion 133 of the door frame 130.

Accordingly, the fastening member 400 may be coupled at the rear of the door 100. Specifically, the fastening member 400 may pass through the coupling hole 141 of the rear frame 140 at the rear of the door 100, and pass through the second handle insertion portion 133 of the door frame 130. Also, the fastening member 400 passing through the second handle insertion portion 133 may be inserted into the second protruding portion 330 of the handle 300.

Accordingly, the second contact portion 350 of the handle 300 and the front side of the front panel 120 may come into close contact with each other by a tightening force of the fastening member 400.

The front panel 120 may include a stainless material. More specifically, the front panel 120 may be provided as a thin steel plate.

Accordingly, the front panel 120 may be provided to be vulnerable to deformation due to external force. In addition, unevenness in the relatively thin front panel 120 may be more noticeable due to light reflection.

In addition, the front panel 120 may be provided in front of the door frame 130 to be spaced apart from the door frame 130 by a predetermined distance.

The front panel 120 and the door frame 130 may be attached to each other by an adhesive member. Because the adhesive member is not applied to an entire surface between the front panel 120 and the door frame 130, a space may be formed between the front panel 120 and the door frame 130.

Accordingly, when fastening the fastening member 400 from behind, the relatively thin front panel 120 may be deformed toward the door frame 130 by a fastening force of the fastening member 400.

However, the first support protrusion 125 and the second support protrusion 126 of the cooking appliance 1 according to an embodiment of the disclosure support the external force caused by the fastening member 400, thereby preventing unevenness from being formed on the front panel 120.

In addition, rigidity of the front panel 120 may be reduced at the first handle coupling portion 121 and the second handle coupling portion 122 which are cut to couple the handle 300 thereto.

Accordingly, the first support protrusion 125 is formed to be adjacent to the first handle coupling portion 121 and the second support protrusion 126 is formed to be adjacent to the second handle coupling portion 122, thereby increasing rigidity of the front panel 120.

In addition, although the first support protrusion 125 and the second support protrusion 126 of the cooking appliance 1 according to an embodiment of the disclosure are shown and described as being recessed from the front panel 120, a method of forming the first support protrusion 125 and the second support protrusion 126 may not be limited thereto.

The first support protrusion 125 and the second support protrusion 126 may be formed by a burring method. The first support protrusion 125 and the second support protrusion 126 may also be formed by bending the front panel 120. In addition, the first support protrusion 125 and second support protrusion 126 may be compressed using a separate jig. Accordingly, the first support protrusion 125 and the second support protrusion 126 may be applied in any form as long as the first support protrusion 125 and the second support protrusion 126 may support to maintain a space between the front panel 120 and the door frame 130.

Furthermore, although it has been shown and described above that the first support protrusion 125 and the second support protrusion 126 are formed on the front panel 120, the first support protrusion 125 and the second support protrusion 126 may be provided to protrude from the door frame 130 toward the front panel 120. That is, the first support protrusion 125 and the second support protrusion 126 may be provided between the front panel 120 and the door frame 130 and be formed on the door frame 130, to maintain a distance between the front panel 120 and the door frame 130 in order to minimize deformation of the front panel 120.

In addition, the first support protrusion 125 and the second support protrusion 126 may be provided as separate components from the front panel 120 and the door frame 130 to maintain a separate state between the front panel 120 and the door frame 130.

While the disclosure has been particularly described with reference to exemplary embodiments, it should be understood by those skilled in the art that various changes in form and detail may be made without departing from the spirit and scope of the disclosure.

What is claimed is:

1. A cooking appliance, comprising:
a main body to accommodate a cooking chamber;
a door to open and close the cooking chamber; and
a handle, mountable on a front of the door, including a contact portion,
wherein the door includes:
a door frame; and
a front panel arrangeable in front of the door frame so that while the front panel is arranged in front of the door frame, the front panel is in contact with the contact portion of the handle while the handle is mounted on the front of the door, and the front panel including a support protrusion extending toward the door frame from an area of the front panel which corresponds to the contact portion of the handle in contact with the front panel of the door to thereby prevent deformation of the door due to operation of the handle.

2. The cooking appliance of claim 1, wherein the support protrusion is in contact with a front side of the door frame to allow the front panel and the door frame to be spaced apart from each other.

3. The cooking appliance of claim 1, wherein the support protrusion is recessed rearward from a front side of the front panel.

4. The cooking appliance of claim 3, wherein the support protrusion includes:
a connection portion extending rearward of the front panel; and
a support portion connectable to the connection portion to be in surface contact with a front side of the door frame.

5. The cooking appliance of claim 1, wherein the handle further includes a protruding portion extending rearward from the contact portion to allow a fastening member to be inserted.

6. The cooking appliance of claim 5, wherein the support protrusion is formed at a position facing the contact portion of the handle.

7. The cooking appliance of claim 5, wherein the front panel includes a handle coupling portion formed to be cut to allow the protruding portion of the handle to pass through and formed in an area corresponding to the contact portion of the handle.

8. The cooking appliance of claim 7, wherein the support protrusion is formed at an outer side of the front panel than the handle coupling portion.

9. The cooking appliance of claim 7, wherein the door frame includes a handle insertion portion extending rearward to receive the protruding portion passing through the handle coupling portion.

10. The cooking appliance of claim 9, further comprising:
a rear frame behind the door frame and in which a coupling hole is formed at a position corresponding to the handle insertion portion,
wherein the fastening member passes through the coupling hole and the handle insertion portion from behind, and is insertable into the protruding portion of the handle, so as to allow the contact portion of the handle to come into close contact with a front side of the front panel.

11. The cooking appliance of claim 1, wherein the support protrusion is formed in an area where the handle is mounted on the front panel.

12. The cooking appliance of claim 1, wherein the support protrusion is in a circular shape.

13. The cooking appliance of claim 1, wherein the door frame includes a guide protrusion extending toward the handle to be received in the handle, and
the front panel includes a protrusion through portion through which the guide protrusion passes.

14. The cooking appliance of claim 13, wherein the guide protrusion is formed at a position biased to one side with respect to a direction in which the handle extends to prevent misassembly of the handle.

15. The cooking appliance of claim 1, wherein the front panel includes a stainless material.
